(19) United States
(12) Patent Application Publication
(10) Pub. No.: US 2021/0258349 A1
(43) Pub. Date: Aug. 19, 2021

(54) SYSTEM AND METHOD FOR DATA EXTRACTION, PROCESSING, AND MANAGEMENT ACROSS MULTIPLE COMMUNICATION PLATFORMS

(71) Applicant: QOMPLX, Inc., Tysons, VA (US)

(72) Inventors: Jason Crabtree, Vienna, VA (US); Andrew Sellers, Monument, CO (US)

(21) Appl. No.: 17/106,809

(22) Filed: Nov. 30, 2020

Related U.S. Application Data
(63) Continuation-in-part of application No. 15/931,534, filed on May 13, 2020.
Application No. 15/931,534 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017.
Application No. 15/616,427 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016.
Application No. 15/206,195 is a continuation-in-part of application No. 15/186,453, filed on Jun. 18, 2016.
Application No. 15/186,453 is a continuation-in-part of application No. 15/166,158, filed on May 26, 2016.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 14/925,974 is a continuation-in-part of application No. 15/931,534, filed on May 13, 2020.
Application No. 15/931,534 is a continuation-in-part of application No. 15/683,765, filed on Aug. 22, 2017.
Application No. 15/683,765 is a continuation-in-part of application No. 15/409,510, filed on Jan. 18, 2017.
Application No. 15/409,510 is a continuation-in-part of application No. 15/379,899, filed on Dec. 15, 2016.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/673,368, filed on Aug. 9, 2017.
Application No. 15/673,368 is a continuation-in-part of application No. 15/376,657, filed on Dec. 13, 2016, now Pat. No. 10,402,906.
Application No. 15/376,657 is a continuation-in-part of application No. 15/931,534, filed on May 13, 2020.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/489,716, filed on Apr. 17, 2017.
Application No. 15/489,716 is a continuation-in-part of application No. 15/409,510, filed on Jan. 18, 2017.
Application No. 15/409,510 is a continuation-in-part of application No. 15/931,534, filed on May 13, 2020.
Application No. 15/931,534 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/655,113 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/141,752, filed on Apr. 28, 2016, now Pat. No. 10,860,962.
Application No. 15/141,752 is a continuation-in-part of application No. 15/616,427, filed on Jun. 7, 2017.
Application No. 15/616,427 is a continuation-in-part of application No. 14/925,974, filed on Oct. 28, 2015, now abandoned.
Application No. 14/925,974 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/616,427, filed on Jun. 7, 2017.
Application No. 15/616,427 is a continuation-in-part of application No. 15/489,716, filed on Apr. 17, 2017.
Application No. 15/489,716 is a continuation-in-part of application No. 15/931,534, filed on May 13, 2020.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016.
(60) Provisional application No. 62/568,298, filed on Oct. 4, 2017.
(60) Provisional application No. 62/568,291, filed on Oct. 4, 2017.

(51) Int. Cl. H04L 29/06; G06F 16/951; G06F 16/2458

(52) U.S. Cl. CPC H04L 63/20; H04L 63/1425; H04L 63/1441; G06F 16/2477; G06F 16/951

(57) ABSTRACT

A system for data extraction, processing, and management across multiple communication mediums is provided, comprising a connector service configured to create a first dataset from a client, user, or external service provider; a data monitor and extractor configured to create a second dataset by extracting data regarding the data of interest from other and external sources; a knowledge graph constructor configured to compile the first and second datasets into a graph and timeseries-based third dataset; and a data analysis service configured to process and analyze the third dataset to determine a performance rating of the data of interest from the client, user, or external service provider.

### CROSS-REFERENCE TO RELATED APPLICATIONS

| Application | | |
|---|---|---|
| Ser. No. | Date Filed | Title |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/777,270 | Jan. 30, | CYBERSECURITY PROFILING AND |
| | 2020 | RATING USING ACTIVE AND PASSIVE |
| | | EXTERNAL RECONNAISSANCE |
| | | which is a continuation-in-part of: |
| 16/720,383 | Dec. 19, | RATING ORGANIZATION |
| | 2019 | CYBERSECURITY USING ACTIVE AND |
| | | PASSIVE EXTERNAL RECONNAISSANCE |
| | | which is a continuation of: |
| 15/823,363 | Nov. 27, | RATING ORGANIZATION |
| Pat. No. | 2017 | CYBERSECURITY USING ACTIVE AND |
| 10,560,483 | Issue Date | PASSIVE EXTERNAL RECONNAISSANCE |
| | Feb. 11, | which is a continuation-in-part of: |
| | 2020 | |
| 15/725,274 | Oct. 4, | APPLICATION OF ADVANCED |
| Pat. No. | 2017 | CYBERSECURITY THREAT MITIGATION |
| 10,609,079 | Issue Date | TO ROGUE DEVICES, PRIVILEGE |
| | Mar. 31, | ESCALATION, AND RISK-BASED |
| | 2020 | VULNERABILITY AND PATCH |
| | | MANAGEMENT |
| | | which is a continuation-in-part of: |
| 15/655,113 | Jul. 20, | ADVANCED CYBERSECURITY THREAT |
| Pat. No. | 2017 | MITIGATION USING BEHAVIORAL AND |
| 10,735,456 | Issue Date | DEEP ANALYTICS |
| | Aug. 4, | which is a continuation-in-part of: |
| | 2020 | |
| 15/616,427 | Jun. 7, | RAPID PREDICTIVE ANALYSIS OF VERY |
| | 2017 | LARGE DATA SETS USING AN ACTOR- |
| | | DRIVEN DISTRIBUTED |
| | | COMPUTATIONAL GRAPH |
| | | and is also a continuation-in-part of: |
| 15/237,625 | Aug. 15, | DETECTION MITIGATION AND |
| Pat. No. | 2016 | REMEDIATION OF CYBERATTACKS |
| 10,248,910 | Issue Date | EMPLOYING AN ADVANCED CYBER- |
| | Apr. 2, | DECISION PLATFORM |
| | 2019 | which is a continuation-in-part of: |
| 15/206,195 | Jul. 8, | ACCURATE AND DETAILED MODELING |
| | 2018 | OF SYSTEMS WITH LARGE COMPLEX |
| | | DATASETS USING A DISTRIBUTED |
| | | SIMULATION ENGINE |
| | | which is a continuation-in-part of: |
| 15/186,453 | Jun. 18, | SYSTEM FOR AUTOMATED CAPTURE |
| | 2016 | AND ANALYSIS OF BUSINESS |
| | | INFORMATION FOR RELIABLE BUSINESS |
| | | VENTURE OUTCOME PREDICTION |
| | | which is a continuation-in-part of: |
| 15/166,158 | May 26, | SYSTEM FOR AUTOMATED CAPTURE |
| | 2016 | AND ANALYSIS OF BUSINESS |
| | | INFORMATION FOR SECURITY AND |
| | | CLIENT-FACING INFRASTRUCTURE |
| | | RELIABILITY |
| | | which is a continuation-in-part of: |
| 15/141,752 | Apr. 28, | SYSTEM FOR FULLY INTEGRATED |
| | 2016 | CAPTURE, AND ANALYSIS OF BUSINESS |
| | | INFORMATION RESULTING IN |
| | | PREDICTIVE DECISION MAKING AND |
| | | SIMULATION |
| | | which is a continuation-in-part of: |
| 15/091,563 | Apr. 5, | SYSTEM FOR CAPTURE, ANALYSIS AND |
| Pat. No. | 2016 | STORAGE OF TIME SERIES DATA FROM |
| 10,204,147 | Issue Date | SENSORS WITH HETEROGENEOUS |
| | Feb. 12, | REPORT INTERVAL PROFILES |
| | 2019 | and is also a continuation-in-part of: |
| 14/986,536 | Dec. 31, | DISTRIBUTED SYSTEM FOR LARGE |
| Pat. No. | 2015 | VOLUME DEEP WEB DATA |
| 10,210,255 | Issue Date | EXTRACTION |
| | Feb. 19, | and is also a continuation-in-part of: |
| | 2019 | |
| 14/925,974 | Oct. 28, | RAPID PREDICTIVE ANALYSIS OF VERY |
| | 2015 | LARGE DATA SETS USING THE |
| | | DISTRIBUTED COMPUTATIONAL |
| | | GRAPH |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 15/683,765 | Aug. 22, | PREDICTIVE LOAD BALANCING FOR A |
| | 2017 | DIGITAL ENVIRONMENT |
| | | which is a continuation-in-part of: |
| 15/409,510 | Jan. 18, | MULTI-CORPORATION VENTURE PLAN |
| | 2017 | VALIDATION EMPLOYING AN |
| | | ADVANCED DECISION PLATFORM |
| | | which is a continuation-in-part of: |
| 15/379,899 | Dec. 15, | INCLUSION OF TIME SERIES |
| | 2016 | GEOSPATIAL MARKERS IN ANALYSES |
| | | EMPLOYING AN ADVANCED CYBER- |
| | | DECISION PLATFORM |
| | | which is a continuation-in-part of: |
| 15/376,657 | Dec. 13, | QUANTIFICATION FOR INVESTMENT |
| Pat. No. | 2016 | VEHICLE MANAGEMENT EMPLOYING |
| 10,402,906 | Issue Date | AN ADVANCED DECISION PLATFORM |
| | Sep. 3, | which is a continuation-in-part of: |
| | 2019 | |
| 15/237,625 | Aug. 15, | DETECTION MITIGATION AND |
| Pat. No. | 2016 | REMEDIATION OF CYBERATTACKS |
| 10,248,910 | Issue Date | EMPLOYING AN ADVANCED CYBER- |
| | Apr. 2, | DECISION PLATFORM |
| | 2019 | |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/718,906 | Dec. 18, | PLATFORM FOR HIERARCHY |
| | 2019 | COOPERATIVE COMPUTING |
| | | which is a continuation of: |
| 15/879,182 | Jan. 24, | PLATFORM FOR HIERARCHY |
| Pat. No. | 2018 | COOPERATIVE COMPUTING |
| 10,514,954 | Issue Date | which is a continuation-in-part of: |
| | Dec. 24, | |
| | 2019 | |
| 15/850,037 | Dec. 21, | ADVANCED DECENTRALIZED |
| | 2017 | FINANCIAL DECISION PLATFORM |
| | | which is a continuation-in-part of: |
| 15/673,368 | Aug. 9, | AUTOMATED SELECTION AND |
| | 2017 | PROCESSING OF FINANCIAL MODELS |
| | | which is a continuation-in-part of: |
| 15/376,657 | Dec. 13, | QUANTIFICATION FOR INVESTMENT |
| Pat. No. | 2016 | VEHICLE MANAGEMENT EMPLOYING |
| 10,402,906 | Issue Date | AN ADVANCED DECISION PLATFORM |
| | Sep. 3, | |
| | 2019 | |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/718,906 | Dec. 18, | PLATFORM FOR HIERARCHY |
| | 2019 | COOPERATIVE COMPUTING |
| | | which is a continuation of: |
| 15/879,182 | Jan. 24, | PLATFORM FOR HIERARCHY |
| Pat. No. | 2018 | COOPERATIVE COMPUTING |
| 10,514,954 | Issue Date | which is a continuation-in-part of: |
| | Dec. 24, | |
| | 2019 | |
| 15/850,037 | Dec. 21, | ADVANCED DECENTRALIZED |
| | 2017 | FINANCIAL DECISION PLATFORM |
| | | which is a continuation-in-part of: |
| 15/489,716 | Apr. 17, | REGULATION BASED SWITCHING |
| | 2017 | SYSTEM FOR ELECTRONIC MESSAGE |
| | | ROUTING |
| | | which is a continuation-in-part of: |
| 15/409,510 | Jan. 18, | MULTI-CORPORATION VENTURE PLAN |
| | 2017 | VALIDATION EMPLOYING AN |
| | | ADVANCED DECISION PLATFORM |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 15/905,041 | Feb. 28, | AUTOMATED SCALABLE CONTEXTUAL |
| Pat. No. | 2018 | DATA COLLECTION AND EXTRACTION |
| 10,706,063 | Issue Date | SYSTEM |
| | Jul. 7, | which is a continuation-in-part of: |
| | 2020 | |
| 15/237,625 | Aug. 15, | DETECTION MITIGATION AND |
| Pat. No. | 2016 | REMEDIATION OF CYBERATTACKS |
| 10,248,910 | Issue Date | EMPLOYING AN ADVANCED CYBER- |
| | Apr. 2, | DECISION PLATFORM |
| | 2019 | |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/191,054 | Nov. 14, | SYSTEM AND METHOD FOR |
| Pat. No. | 2018 | COMPREHENSIVE DATA LOSS |
| 10,681,074 | Issue Date | PREVENTION AND COMPLIANCE |
| | Jun. 9, | MANAGEMENT |
| | 2020 | which is a continuation-in-part of: |
| 15/655,113 | Jul. 20, | ADVANCED CYBERSECURITY THREAT |
| Pat. No. | 2017 | MITIGATION USING BEHAVIORAL AND |
| 10,735,456 | Issue Date | DEEP ANALYTICS |
| | Aug. 4, | |
| | 2020 | |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/654,309 | Oct. 16, | SYSTEM AND METHOD AUTOMATED |
| | 2019 | ANALYSIS OF LEGAL DOCUMENTS |
| | | WITHIN AND ACROSS SPECIFIC FIELDS |
| | | which is a continuation-in-part of: |
| 15/847,443 | Dec. 19, | SYSTEM AND METHOD FOR |
| | 2017 | AUTOMATIC CREATION OF |
| | | ONTOLOGICAL DATABASES AND |
| | | SEMANTIC SEARCHING |
| | | which is a continuation-in-part of: |
| 15/790,457 | Oct. 23, | DISTRIBUTABLE MODEL WITH BIASES |
| | 2017 | CONTAINED WITHIN DISTRIBUTED |
| | | DATA |
| | | which claims benefit of and priority to: |
| 62/568,298 | Oct. 4, | DISTRIBUTABLE MODEL WITH BIASES |
| | 2017 | CONTAINED IN DISTRIBUTED DATA |
| | | and is also a continuation-in-part of: |
| 15/790,327 | Oct. 23, | DISTRIBUTABLE MODEL WITH |
| | 2017 | DISTRIBUTED DATA |
| | | which claims benefit of and priority to: |
| 62/568,291 | Oct. 4, | DISTRIBUTABLE MODEL WITH |
| | 2017 | DISTRIBUTED DATA |
| | | and is also a continuation-in-part of: |
| 15/141,752 | Apr. 28, | SYSTEM FOR FULLY INTEGRATED |
| | 2016 | CAPTURE, AND ANALYSIS OF BUSINESS |
| | | INFORMATION RESULTING IN |
| | | PREDICTIVE DECISION MAKING AND |
| | | SIMULATION |
| | | and is also a continuation-in-part of: |
| 15/616,427 | Jun. 7, | RAPID PREDICTIVE ANALYSIS OF VERY |
| | 2017 | LARGE DATA SETS USING AN ACTOR- |
| | | DRIVEN DISTRIBUTED |
| | | COMPUTATIONAL GRAPH |
| | | which is a continuation-in-part of: |
| 14/925,974 | Oct. 28, | RAPID PREDICTIVE ANALYSIS OF VERY |
| | 2015 | LARGE DATA SETS USING THE |
| | | DISTRIBUTED COMPUTATIONAL |
| | | GRAPH |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/654,309 | Oct. 16, | SYSTEM AND METHOD AUTOMATED |
| | 2019 | ANALYSIS OF LEGAL DOCUMENTS |
| | | WITHIN AND ACROSS SPECIFIC FIELDS |
| | | which is a continuation-in-part of: |
| 15/847,443 | Dec. 19, | SYSTEM AND METHOD FOR |
| | 2017 | AUTOMATIC CREATION OF |
| | | ONTOLOGICAL DATABASES AND |
| | | SEMANTIC SEARCHING |
| | | which is a continuation-in-part of: |
| 15/616,427 | Jun. 7, | RAPID PREDICTIVE ANALYSIS OF VERY |
| | 2017 | LARGE DATA SETS USING AN ACTOR- |
| | | DRIVEN DISTRIBUTED |
| | | COMPUTATIONAL GRAPH |
| | | and is also a continuation-in-part of: |
| 15/489,716 | Apr. 17, | REGULATION BASED SWITCHING |
| | 2017 | SYSTEM FOR ELECTRONIC MESSAGE |
| | | ROUTING |
| Current | Herewith | SYSTEM AND METHOD FOR DATA |
| application | | EXTRACTION, PROCESSING, AND |
| | | MANAGEMENT ACROSS MULTIPLE |
| | | COMMUNICATION PLATFORMS |
| | | Is a continuation-in-part of: |
| 15/931,534 | May 13, | SECURE POLICY-CONTROLLED |
| | 2020 | PROCESSING AND AUDITING ON |
| | | REGULATED DATA SETS |
| | | which is a continuation-in-part of: |
| 16/660,727 | Oct. 22, | HIGHLY SCALABLE DISTRIBUTED |
| | 2019 | CONNECTION INTERFACE FOR DATA |
| | | CAPTURE FROM MULTIPLE NETWORK |
| | | SERVICE SOURCES |
| | | which is a continuation of: |
| 15/229,476 | Aug. 5, | HIGHLY SCALABLE DISTRIBUTED |
| Pat. No. | 2016 | CONNECTION INTERFACE FOR DATA |
| 10,454,791 | Issue Date | CAPTURE FROM MULTIPLE NETWORK |
| | Oct. 22, | SERVICE SOURCES |
| | 2019 | which is a continuation-in-part of: |
| 15/206,195 | Jul. 8, | ACCURATE AND DETAILED MODELING |
| | 2016 | OF SYSTEMS WITH LARGE COMPLEX |
| | | DATASETS USING A DISTRIBUTED |
| | | SIMULATION ENGINE |

the entire specification of each of which is incorporated herein by reference.

### BACKGROUND OF THE INVENTION

### Field of the Invention

The disclosure relates to the field of data processing and management, specifically natural language processing and unstructured data processing.

### Discussion of the State of the Art

Currently, managing data across multiple platforms requires a heavy burden from human users to track, update, and otherwise manage data. Manual management of this data is also necessary as most of it is unstructured, or in other words, not intended for automatic ingestion of computer systems. Typically, data that is easily ingested is already structured as such, but unstructured data has no known schema by which any current solution can use. Entities wanting to analyze their data across multiple communication channels (radio, television, Internet, mobile, etc.) currently have no automated way to do it. Currently, there must exist a team of individuals who perform the management across all platforms and must manually bring it together in one location. This means transcription of analog sources, conversions for dissimilar digital formats, and the like.

Consider marketing campaign tracking and management, there currently exists a strong delineation and separation amongst mediums and platforms in which marketing assets may be deployed, for example, internet, print, tv or video, radio, billboards, and the like. Besides the lack of tracking across the various mediums, tracking data may often lack depth, and other aspects which may be helpful in steering a marketing campaign may not be sufficiently tracked. For instance, awareness-building efforts, customer engagement, whether site content and an advertisement match in context, correlative analysis, and the like all provide valuable insight to a company in how they should market their products.

Another issue which may be lacking in present marketing tracking platforms is the ability to differentiate traffic quality, for example, to determine whether traffic led to a destination through an advertisement displayed on a website is legitimate, or whether the traffic is from web crawlers or spam bots. Fake traffic is increasingly becoming a problem for both marketers, as well as advertisement distribution networks such as GOOGLE™ and FACEBOOK™, in that advertisers may be paying to display advertisements to bots and not actual human users.

What is a needed is a unified platform which provides a user-friendly means of tracking structured and unstructured data across multiple mediums. Such as system should also provide tools and resources for in-depth tracking via natural language processing and advanced data extraction and processing.

### SUMMARY OF THE INVENTION

Accordingly, the inventor has conceived, and reduced to practice, a system and method for data extraction, processing, and management across multiple communication mediums is provided, comprising a connector service configured to create a first dataset from a client, user, or external service provider; a data monitor and extractor configured to create a second dataset by extracting data regarding the data of interest from other and external sources; a knowledge graph constructor configured to compile the first and second datasets into a graph and timeseries-based third dataset; and a data analysis service configured to process and analyze the third dataset to determine a performance rating of the data of interest from the client, user, or external service provider.

According to a preferred embodiment of the invention, a system for data extraction, processing, and management across multiple communication mediums is disclosed, comprising: a computing device comprising a memory, a processor, and a non-volatile data storage device; a connector service comprising a first plurality of programming instructions stored in the memory and operable on the processor, wherein the first plurality of programming instructions, when operating on the processor, cause the computing device to: create a first dataset by gathering data of interest supplied by an interested party; a data monitor and extractor comprising a second plurality of programming instructions stored in the memory and operable on the processor, wherein the second plurality of programming instructions, when operating on the processor, cause the computing device to: create a second dataset by extracting data of interest from external sources; a knowledge graph constructor comprising a third plurality of programming instructions stored in the memory and operable on the processor, wherein the third plurality of programming instructions, when operating on the processor, cause the computing device to: compile the first and second datasets into a graph and timeseries-based third dataset; and a data analysis service comprising a fourth plurality of programming instructions stored in the memory and operable on the processor, wherein the fourth plurality of programming instructions, when operating on the processor, cause the computing device to: process and analyze the third dataset by performing at least a plurality of graph computations and transformations and edge analysis to at least determine a data performance rating based at least on clickstream data; and a reporting service comprising a fourth plurality of programming instructions stored in the memory and operable on the processor, wherein the fourth plurality of programming instructions, when operating on the processor, cause the computing device to: compile a real-time report in which at least a portion is based on clickstream data of the data of interest.

According to another preferred embodiment of the invention, a method for data extraction, processing, and management across multiple communication mediums is disclosed, comprising the steps of: creating a first dataset by gathering data of interest supplied by an interested party; creating a second dataset by extracting data of interest from external sources; compiling the first and second datasets into a graph and timeseries-based third dataset; and processing and analyzing the third dataset by performing at least a plurality of graph computations and transformations and edge analysis to at least determine a data performance rating based at least on clickstream data; and compiling a real-time report in which at least a portion is based on clickstream data of the data of interest.

According to various aspects of the invention, the system further comprising an automated planning service comprising a memory, a processor, and a fifth plurality of programming instructions stored in the memory thereof and operable on the processor thereof, wherein the fifth programmable instructions, when operating on the processor, cause the processor to: perform predictive analysis using at least the third dataset; and determine steps for improving performance of the data of interest based at least on results of the predictive analysis; the connector service is configured to connect to an inventory tracking system to include inventory information in the third dataset; the data analysis service performs a plurality of graph analysis and transformations and edge analysis to conduct sentiment analysis to determine sentiment regarding the data of interest; the sentiment analysis is accomplished by natural language understanding; the data analysis service performs a plurality of graph analysis and transformations and edge analysis to conduct correlative analysis to determine a cause for change in performance for the data of interest.

According to additional various aspects of the invention, the first dataset gathers data regarding an associated marketing campaign from at least an external service provider by connecting through an application programming interface of the external service provider, wherein the associated marketing campaign comprises a deployed advertisement; the second dataset extracts data regarding the associated marketing campaign from external sources including at least social media sources; the system further comprising a contextual-based adjuster comprising a sixth plurality of programming instructions stored in the memory and operable on the processor, wherein the sixth plurality of programming instructions, when operating on the processor, cause the computing device to perform the steps of: retrieving a marketing context from a database stored on the non-volatile data storage device; analyzing the contents of a web page containing the deployed advertisement; determining whether the contents of the web page are relevant to the deployed advertisement; and where the contents of the web page are not relevant to the deployed advertisement, uploading a different advertisement to the associated marketing campaign; the data analysis service performs a plurality of graph analysis and transformations and edge analysis to determine quality of advertisement traffic based at least on clickstream analysis.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of an operating system according to an embodiment of the invention.

FIG. 2 is a diagram of an exemplary architecture of an automated planning service module and related modules according to an embodiment of the invention.

FIG. 3 is a diagram of an indexed global tile module as per one embodiment of the invention.

FIG. 4 is a flow diagram illustrating the function of the indexed global tile module as per one embodiment of the invention.

FIG. 5 is a block diagram illustrating an exemplary system employing a platform for management of marketing campaigns across multiple distribution mediums according to various embodiments of the invention.

FIG. 6 is a block diagram of an exemplary marketing data analysis service according to various embodiments of the invention.

FIG. 7 is a flow chart illustrating a method for initial data gathering according to various embodiments of the invention.

FIG. 8 is a flow chart illustrating a method for contextual-based marketing adjustment according to various embodiments of the invention.

FIG. 9 is a flow diagram illustrating a method for updating an existing marketing campaign with new data according to various embodiments of the invention.

FIG. 10 is a flowchart illustrating an exemplary method for extracting data from graph-timeseries data analysis according to various embodiments of the invention.

FIG. 11 is a block diagram illustrating an exemplary hardware architecture of a computing device used in various embodiments of the invention.

FIG. 12 is a block diagram illustrating an exemplary logical architecture for a client device, according to various embodiments of the invention.

FIG. 13 is a block diagram illustrating an exemplary architectural arrangement of clients, servers, and external services, according to various embodiments of the invention.

FIG. 14 is another block diagram illustrating an exemplary hardware architecture of a computing device used in various embodiments of the invention.

### DETAILED DESCRIPTION

The inventor has conceived, and reduced to practice, a system and method for data extraction, processing, and management across multiple communication mediums is provided, comprising a connector service configured to create a first dataset from a client, user, or external service provider; a data monitor and extractor configured to create a second dataset by extracting data regarding the data of interest from other and external sources; a knowledge graph constructor configured to compile the first and second datasets into a graph and timeseries-based third dataset; and a data analysis service configured to process and analyze the third dataset to determine a performance rating of the data of interest from the client, user, or external service provider.

The flaw in current solutions is a reliance on structured data (i.e., data with a known and fixed schema). Meanwhile, what is disclosed is a preferred embodiment that uses Natural Language Processing (NLP) and data cleansing/extraction technology in order to facilitate the development of metrics and content for non-print and Internet marketing. For example, a voice-to-text transcription is coupled with data extraction to pass video and radio content from its source into a NLP engine and organized into an ontology using Knowledge Base Construction (KBC) process via a VOIP (Voice Over Internet Protocol) API (Application Programming Interface). Furthermore, because the advanced ingestion and NLP processing taking place on the ingested data, the data content that is commingled with information from a particular advertiser can be parsed out for enhanced metrics and analysis for overall coalescing of marketing data. As the following example illustrates, a large petroleum company is unlikely to want ads presented next to content/blog posts which focus on injustices or environmental calamities associated with big oil. At a minimum, the petroleum company is likely to desire to run different ads, such that it can correct misperceptions and salvage its brand without a tone-deaf ad campaign adjacent to adversarial content.

Furthermore, the preferred embodiment addresses a core challenge associated with improving ad quality and metrics for buyers. GOOGLE™, FACEBOOK™, and others have struggled extensively with fake traffic and advertisers are demanding more information on where (and with what else) ads are placed/positioned near. Metrics improvements are central to campaign optimization capabilities to better serve clients and enable growth at scale. In order to achieve this, large volumes of related and adjacent data must be ingested to form a data-dense scope of the advertising environment such that automatic ad placing decisions may be confidently made without human intervention. And such is the case that humans cannot reasonably visit, experience, log, analyze, predict, place, test, monitor, and reevaluate the advertising landscape to the degree of the disclosed embodiments where optimal ad placement is paramount. The disclosed invention and its embodiments use batch-oriented processing, streaming ingestion, and databases to handle visualization and specification of polygons on the client-side while supporting maintenance of geographic areas of interest on the server-side.

In a typical embodiment, a platform is provided that provides unified tracking across many different distribution mediums. The platform may also include tools for in-depth tracking of marketing statistics, such as awareness tracking, quality of traffic drawn in by an advertisement, overall performance, and the like. The platform may also provide strategies to boost performance of a marketing campaign based on predictive analysis with machine learning models that may be automatically improved over time as more marketing data become available.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, a “swimlane” is a communication channel between a time series sensor data reception and apportioning device and a data store meant to hold the apportioned data time series sensor data. A swimlane is able to move a specific, finite amount of data between the two devices. For example a single swimlane might reliably carry and have incorporated into the data store, the data equivalent of 5 seconds worth of data from 10 sensors in 5 seconds, this being its capacity. Attempts to place 5 seconds worth of data received from 6 sensors using one swimlane would result in data loss.

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

### Conceptual Architecture

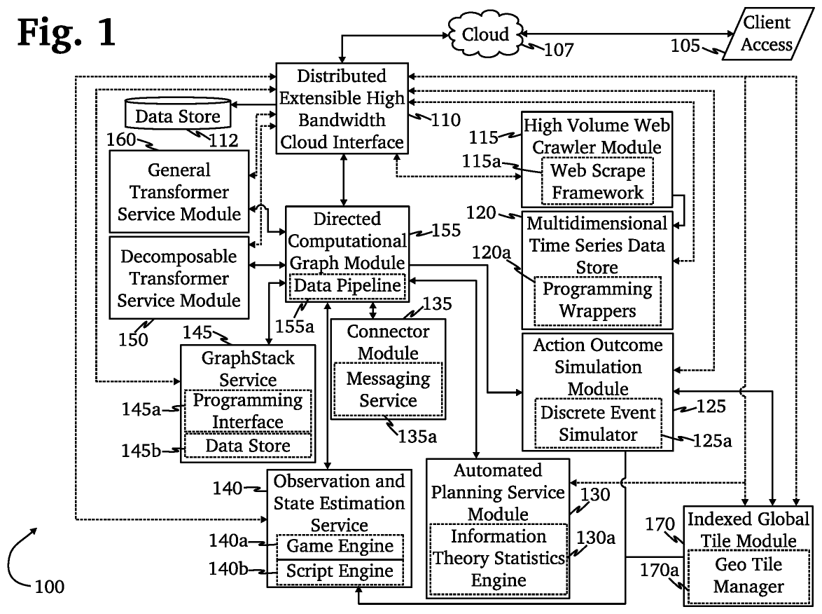

FIG. 1 is a diagram of an exemplary architecture of an operating system 100 according to an embodiment of the invention. Client access to system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information and a data store 112 such as, but not limited to MONGODB™ COUCHDB™, CASSANDRA™ or REDIS™ depending on the embodiment. Much of the business data analyzed by the system both from sources within the confines of the client business, and from cloud based sources 107, public or proprietary such as, but not limited to: subscribed business field specific data services, external remote sensors, subscribed satellite image and data feeds and web sites of interest to business operations both general and field specific, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and a graph stack service 145. Directed computational graph module 155 retrieves one or more streams of data from a plurality of sources, which includes, but is not limited to, a plurality of physical sensors, network service providers, web based questionnaires and surveys, monitoring of electronic infrastructure, crowd sourcing campaigns, and human input device information. Within directed computational graph module 155, data may be split into two identical streams in a specialized pre-programmed data pipeline 155a, wherein one sub-stream may be sent for batch processing and storage while the other sub-stream may be reformatted for transformation pipeline analysis. The data may be then transferred to a general transformer service module 160 for linear data transformation as part of analysis or the decomposable transformer service module 150 for branching or iterative transformations that are part of analysis. Directed computational graph module 155 represents all data as directed graphs where the transformations are nodes and the result messages between transformations edges of the graph. High-volume web crawling module 115 may use multiple server hosted preprogrammed web spiders which, while autonomously configured, may be deployed within a web scraping framework 115a of which SCRAPY™ is an example, to identify and retrieve data of interest from web based sources that are not well tagged by conventional web crawling technology. Multiple dimension time series data store module 120 may receive streaming data from a large plurality of sensors that may be of several different types. Multiple dimension time series data store module 120 may also store any time series data encountered by system 100 such as, but not limited to, environmental factors at insured client infrastructure sites, component sensor readings and system logs of some or all insured client equipment, weather and catastrophic event reports for regions an insured client occupies, political communiques and/or news from regions hosting insured client infrastructure and network service information captures (such as, but not limited to, news, capital funding opportunities and financial feeds, and sales, market condition), and service related customer data. Multiple dimension time series data store module 120 may accommodate irregular and high-volume surges by dynamically allotting network bandwidth and server processing channels to process the incoming data. Inclusion of programming wrappers 120a for languages—examples of which may include, but are not limited to, C++, PERL, PYTHON, and ERLANG™—allows sophisticated programming logic to be added to default functions of multidimensional time series database 120 without intimate knowledge of the core programming, greatly extending breadth of function. Data retrieved by multidimensional time series database 120 and high-volume web crawling module 115 may be further analyzed and transformed into task-optimized results by directed computational graph 155 and associated general transformer service 160 and decomposable transformer service 150 modules. Alternately, data from the multidimensional time series database and high-volume web crawling modules may be sent, often with scripted cuing information determining important vertices 145a, to graph stack service module 145 which, employing standardized protocols for converting streams of information into graph representations of that data, for example open graph internet technology (although the invention is not reliant on any one standard). Through the steps, graph stack service module 145 represents data in graphical form influenced by any pre-determined scripted modifications 145a and stores it in a graph-based data store 145b such as GIRAPH™ or a key-value pair type data store REDIS™, or RIAK™, among others, any of which are suitable for storing graph-based information.

Results of the transformative analysis process may then be combined with further client directives, additional business rules and practices relevant to the analysis and situational information external to the data already available in automated planning service module 130, which also runs powerful information theory-based predictive statistics functions and machine learning algorithms 130a to allow future trends and outcomes to be rapidly forecast based upon the current system derived results and choosing each a plurality of possible business decisions. Then, using all or most available data, automated planning service module 130 may propose business decisions most likely to result in favorable business outcomes with a usably high level of certainty. Closely related to the automated planning service module 130 in the use of system-derived results in conjunction with possible externally supplied additional information in the assistance of end user business decision making, action outcome simulation module 125 with a discrete event simulator programming module 125a coupled with an end user-facing observation and state estimation service 140, which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

A significant proportion of the data that is retrieved and transformed by an operating system, both in real world analyses and as predictive simulations that build upon intelligent extrapolations of real world data, may include a geospatial component. The indexed global tile module 170 and its associated geo tile manager 170a may manage externally available, standardized geospatial tiles and may enable other components of an operating system, through programming methods, to access and manipulate meta-information associated with geospatial tiles and stored by the system. An operating system may manipulate this component over the time frame of an analysis and potentially beyond such that, in addition to other discriminators, the data is also tagged, or indexed, with their coordinates of origin on the globe. This may allow the system to better integrate and store analysis specific information with all available information within the same geographical region. Such ability makes possible not only another layer of transformative capability, but may greatly augment presentation of data by anchoring to geographic images including satellite imagery and superimposed maps both during presentation of real world data and simulation runs.

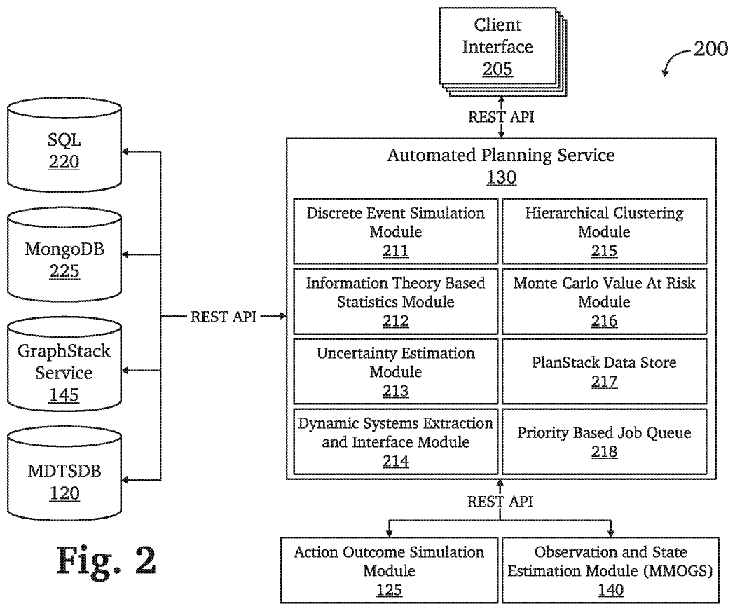

FIG. 2 is a diagram of an exemplary architecture 200 of an automated planning service module 130 and related modules according to an embodiment of the invention. Seen here is a more detailed view of the automated planning service module 130 as depicted in FIG. 1. The module functions by receiving business decision or business venture candidates as well as relevant currently available related data and any campaign analysis modification commands through a client interface 205. Significant amounts of supporting information such as, but not restricted to current business conditions, infrastructure, ongoing venture status, financial status, market conditions, and world events which may impact the current decision or venture that have been collected by the operating system as a whole and stored in such data stores as the multidimensional times series database 120, the analysis capabilities of the directed computational graph module 155 and web-based data retrieval abilities of the high volume web crawler module 115 all of which may be stored in one or more data stores 220, 225 may also be used during simulation of alternative business decision progression, which may entail such variables as, but are not limited to implementation timing, method to end changes, order and timing of constituent part completion or impact of choosing another goal instead of an action currently under analysis.

Contemplated actions may be broken up into a plurality of constituent events that either act towards the fulfillment of the venture under analysis or represent the absence of each event by the discrete event simulation module 211 which then makes each of those events available for information theory based statistical analysis 212, which allows the current decision events to be analyzed in light of similar events under conditions of varying dis-similarity using machine learned criteria obtained from that previous data; results of this analysis in addition to other factors may be analyzed by an uncertainty estimation module 213 to further tune the level of confidence to be included with the finished analysis. Confidence level would, be a weighted calculation of the random variable distribution given to each event analyzed. Prediction of the effects of at least a portion of the events involved with a business venture under analysis within a system as complex as anything from the microenvironment in which the client business operates to more expansive arenas as the regional economy or further, from the perspective of success of the client business is calculated in dynamic systems extraction and inference module 214, which use, among other tools algorithms based upon Shannon entropy, Hartley entropy and mutual information dependence theory.

Of great importance in any business decision or new business venture is the amount of business value that is being placed at risk by choosing one decision over another. Often this value is monetary but it can also be competitive placement, operational efficiency or customer relationship based, for example: the may be the effects of keeping an older, possibly somewhat malfunctioning customer relationship management system one more quarter instead of replacing it for $14 million dollars and a subscription fee. The automated planning service module has the ability predict the outcome of such decisions per value that will be placed at risk using programming based upon the Monte Carlo heuristic model 216 which allows a single “state” estimation of value at risk. It is very difficult to anticipate the amount of computing power that will be needed to complete one or more of these business decision analyses which can vary greatly in individual needs and often are run with several alternatives concurrently. The invention is therefore designed to run on expandable clusters 215, in a distributed, modular, and extensible approach, such as, but not exclusively, offerings of Amazon's AWS. Similarly, these analysis jobs may run for many hours to completion and many clients may be anticipating long waits for simple “what if” options which will not affect their business operations in the near term while other clients may have come upon a pressing decision situation where they need alternatives as soon as possible. This is accommodated by the presence of a job queue that allows analysis jobs to be implemented at one of multiple priority levels from low to urgent. In case of a change in more hypothetical analysis jobs to more pressing, job priorities can also be changed during run without loss of progress using the priority-based job queue 218.

Structured plan analysis result data may be stored in either a general purpose automated planning engine executing Action Notation Modeling Language (ANML) scripts for modeling which can be used to prioritize both human and machine-oriented tasks to maximize reward functions over finite time horizons 217 or through the graph-based data store 145, depending on the specifics of the analysis in complexity and time run.

The results of analyses may be sent to one of two client facing presentation modules, the action outcome simulation module 125 or the more visual simulation capable observation and state estimation module 140 depending on the needs and intended usage of the data by the client.

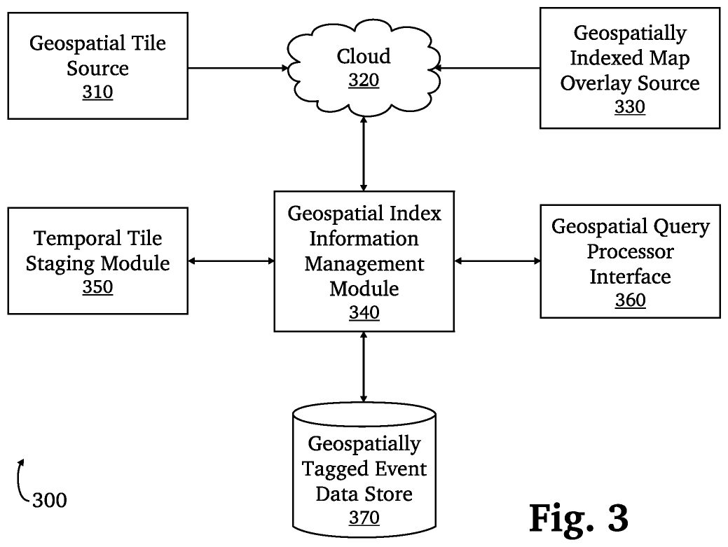

FIG. 3 is a diagram of an indexed global tile module 300 as per one embodiment of the invention. A significant amount of the data transformed and simulated by the operating system has an important geospatial component. Indexed global tile module 170 allows both for the geo-tagging storage of data as retrieved by the system as a whole and for the manipulation and display of data using its geological data to augment the data's usefulness in transformation, for example creating ties between two independently acquired data points to more fully explain a phenomenon; or in the display of real world, or simulated results in their correct geospatial context for greatly increased visual comprehension and memorability. Indexed global tile module 170 may consist of a geospatial index information management module which retrieves indexed geospatial tiles from a cloud-based source 310, 320 known to those skilled in the art, and may also retrieve available geospatially indexed map overlays from a geospatially indexed map overlay source 330 known to those skilled in the art. Tiles and their overlays, once retrieved, represent large amounts of potentially reusable data and are therefore stored for a pre-determined amount of time to allow rapid recall during one or more analyses on a temporal staging module 350. To be useful, it may be required that both the transformative modules of the operating system, such as, but not limited to directed computational graph module 155, automated planning service module 130, action outcome simulation module 125, and observational and state estimation service 140 be capable of both accessing and manipulating the retrieved tiles and overlays. A geospatial query processor interface 360 serves as a program interface between these system modules and geospatial index information management module 340 which fulfills the resource requests through specialized direct tile manipulation protocols, which for simplistic example may include “get tile xxx,” “zoom,” “rotate,” “crop,” “shape,” “stitch,” and “highlight” just to name a very few options known to those skilled in the field. During analysis, the geospatial index information management module may control the assignment of geospatial data and the running transforming functions to one or more swimlanes to expedite timely completion and correct storage of the resultant data with associated geotags. The transformed tiles with all associated transformation tagging may be stored in a geospatially tagged event data store 370 for future review. Alternatively, just the geotagged transformation data or geotagged tile views may be stored for future retrieval of the actual tile and review depending on the need and circumstance. There may also be occasions where time series data from specific geographical locations are stored in multidimensional time series data store 120 with geo-tags provided by geospatial index information management module 340.

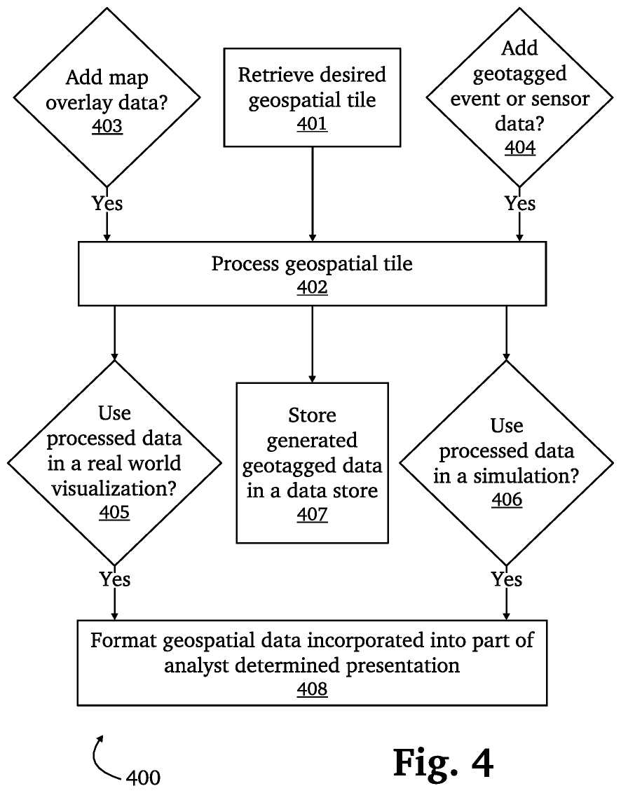

FIG. 4 is a flow diagram illustrating the function 400 of the indexed global tile module as per one embodiment of the invention. Predesignated, indexed geospatial tiles are retrieved from sources known to those skilled in the art at step 401. Available map overlay data, retrieved from one of multiple sources at step 403 known to those skilled in the art may be retrieved per user design. The geospatial tiles may then be processed in one or more of a plurality of ways according to the design of the running analysis at step 402, at which time geo-tagged event or sensor data may be associated with the indexed tile at step 404. Data relating to tile processing, which may include the tile itself is then stored for later review or analysis at step 407. The geo-data, in part, or in its entirety may be used in one or more transformations that are part of a real-world data presentation at step 405. The geo-data in part or in its entirety may be used in one or more transformations that are part of a simulation at step 406. At least some of the geospatial data may be used in an analyst determined direct visual presentation or may be formatted and transmitted for use in third party solutions at step 408.

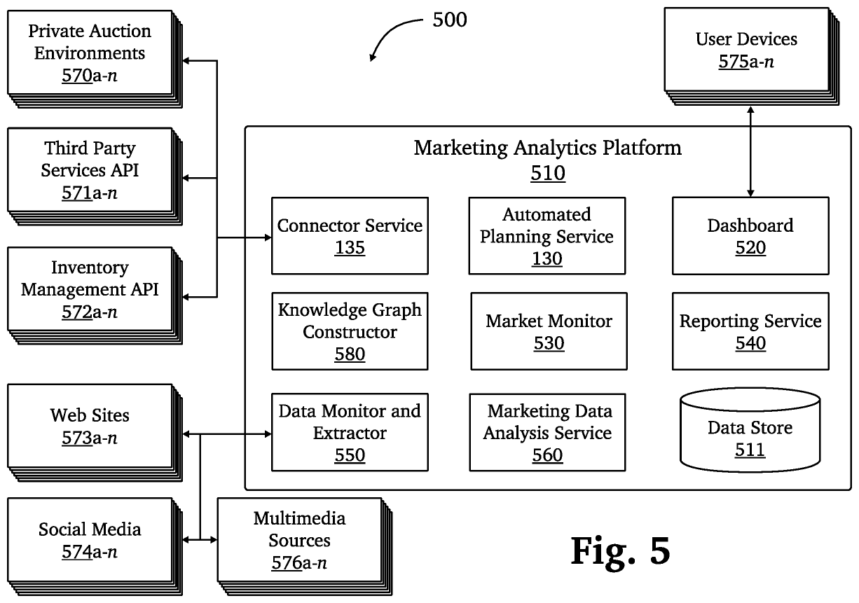

FIG. 5 is a block diagram illustrating an exemplary system 500 employing a platform for management of marketing campaigns across multiple distribution mediums 510 according to various embodiments of the invention. Platform 510 may comprise a connector service 135, an automated planning service 130, a data store 511, a dashboard 520, a market monitor 530, a reporting service 540, a data monitor and extractor 550, a knowledge graph constructor 580, and a marketing data analysis service 560, which may all be configurations of one or more instances of operating system 100 to perform their specific tasks. It should be understood that the components listed may be individual microservices, implemented in logical form, and the like. Additionally, a single system may have more or less components than what is illustrated in FIG. 5. It should also be understood that although the examples used herein may be focused on distribution and tracking of marketing material across various distribution mediums, the disclosed invention may also be applied to tracking anything that involves tracking awareness or market penetration. This may include advertisements, marketing, traditional fund-raising campaigns, crowd-sourced fund-raising campaigns, election campaigns, and the like without any limitations on platforms or mediums used.

Connector 135, part of operating system 100 discussed above, may be configured connect platform 510 to external service providers to continuously monitor, collect data, and distribute data. Connector 135 may also be configured to be used for added functionality instead of a replacement by connecting to existing marketing platforms and working in tandem. External service providers may include, but is not limited to, private auctions 570a-n; third party service providers 571a-n, such as web hosting services, advertisement distribution and exchange platform, affiliate networks, and the like; and inventory management systems 572a-n. Connections may be facilitated through the use of an Application Programming Interface (API), which may be extendable with user-created connector extensions to increase compatibility as required. Once data has been collected, connector 135 may cleanse and formalize data from the various platforms and sources to make the data more uniform before importing into platform 510 to be widely used.

When connector 135 is interfacing with an advertisement distributor, web host, and the like in which marketing assets may be published, connector 135 may be configured to control which advertisements, and in what manner the advertisements may be displayed. Connector 135 may operate across many platforms and mediums, for instance, social media, image sharing platforms, streaming videos, streaming audio, ad-supported games and services which may include augmented reality services and virtual reality services, and the like. For example, connector 135 may display funnel pages to steer a potential customer towards a purchase; or conduct A/B testing on various advertisements or presentation styles to test which one is preferred, which may vary from demographic to demographic, as well as region to region.

Automated planning service 130, also part of operating system 100 discussed above, may be configured to use various machine learning models to perform predictive analysis, and scalable simulations on knowledge graphs generated by knowledge graph constructor 580, and may also use any data gathered from external services, external datasets, crowd-sourced data, and the like. By performing predictive analysis, and graph computations and transformations on the data, automated planning service 130 may determine recommended strategies to improve performance of a marketing campaign or best ways to engage potential customers based at least in part on changing trends, current sentiment, current events, and the like. Automated planning service 130 may also establish data prioritization and rankings based on predictive analysis and graph analysis of available data, and identify any key constraints present in the present workflow that may be remedied. In some embodiments, automated planning service 130 may be configured to implement strategies autonomously when a certain preestablished certainty level of performance gains is reached or surpassed.

Data store 511 may be configured to store marketing data, models, inventory information, campaign settings, generated reports, and the like in a hybrid graph-timeseries format, which may make the data readily processable by other components. Data store 511 may also utilize a multidimensional time series data store 120 with geo-tags provided by geospatial index information management module 340. This may allow platform 510 to track and store marketing data which are geotagged that may be useful in determining an optimal marketing plan for certain regions.

Dashboard 520 may be a user-facing interface and allow for a plurality of users to connect to platform 510 with devices 575a-n. Dashboard 520 may provide a user-friendly interface for manager-level users to managing the settings of platform 510, inventory tracking and management, marketing campaign management, view generated real-time reports, and the like.

Market monitor 530 may be configured to use business operating 100 functions, such as web crawler 115, connector module 135, and multidimensional time-series data server 120, to monitor markets for marketing-related opportunities. For example, market monitor 530 may monitor for media buying opportunities, slots for purposes of arbitrage, direct sales to customers, and the like using graph analysis and transformations, as well as graph edge analysis. Market monitor 530 may also be configured to automatically complete the transactions for purchases.

Reporting service 540 may be configured to use operating system 100 functions, such as graph stack service 145 and directed computation graph module 155 with associated transformer services, to aggregate real-time data to generate reports to be viewable by a human user. Reports may present performance of a particular marketing campaign, performance broken down by regions, recommended strategies for performance improvements, and the like.

Data monitor and extractor 550 may be configured to use operating system 100 functions, such as graph stack 145, web crawler 115, multidimensional time-series data server 120, and the like, to be an extensible component used to continuous monitor, extract data, and formalize the data from various sources that may be relevant to a particular marketing campaign. Extracted data may comprise natural language data in the form of text, speech, videos, or images. Sources may include web sites 573a-n, such as news sources and blogs; social media sites 574a-n, such as FACEBOOK, TWITTER, INSTAGRAM, and SNAPCHAT; multimedia sources 576a-n like video and audio streaming services, such as YOUTUBE and SPOTIFY; and the like. Unlike connector 150, extractor 550 may not need to connect to the sites with an API. The extracted data may then be converted to a graph-based time-series formalism and stored for analysis. Natural language processing and natural language understanding may be used to perform such conversion on extracted data.

Knowledge graph constructor 580 may be configured to use operating system 100 functions, such as graph stack service 145 and directed computation graph module 155 with associated transformer services, to uses gathered data to construct a knowledge graph, which may be a collection of gathered data converted to a hybrid graph-timeseries format readily processable by components of operating system 100 and platform 510 for marketing analysis.

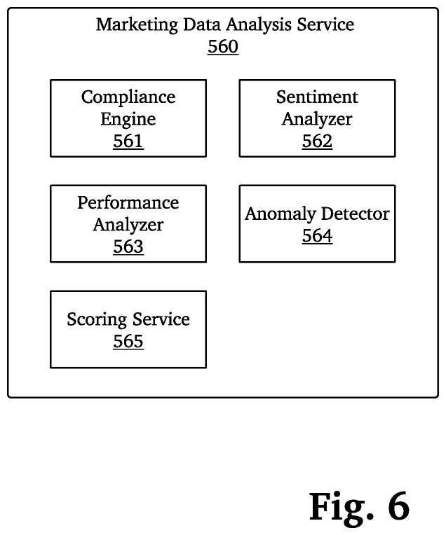

Marketing data analysis service 560 may be configured to use operating system 100 functions, such as graph stack service 145 and directed computation graph module 155 with associated transformer services, for observation and retraining of models based on results of marketing data analytics and knowledge graph of a particular marketing campaign. As more data becomes available, the models may be able to become more specialized and in-depth. Referring now to FIG. 6, marketing data analysis service 560 may comprise a compliance engine 561, a sentiment analyzer 562, a performance analyzer 563, an anomaly detector 564, and a scoring service 565.

Compliance engine 561 may be configured to perform graph analysis, transformations, and edge analysis on knowledge graphs and other available data for compliance-related data, and ensure that there is available information for reporting service 540 to have generate reports that are within the standards of any applicable regulations.

Sentiment analyzer 562 may be configured to analyze knowledge graphs and other available data using, for example, edge analysis, graph analysis, and transformations, to determine current market sentiment regarding a particular product being marketed, competing products, opinions on current marketing campaigns, and the like.

Performance analyzer 563 may be configured to analyze knowledge graphs and other available data using, for example, edge analysis, graph analysis, and transformations, to determine marketing-related performance, such product awareness, click-through-rates of displayed advertisements, clickstream analysis, quality and legitimacy of traffic originating from advertisements, and the like. Performance based on presentation of a particular marketing campaign may also be analyzed, for example, certain mediums, layouts, colors, and the like performs more favorably. Performance analyzer 563 may also perform correlative analysis on whether change in performance is attributed to current trends or changes in marketing strategies.

Anomaly detection service 564 may be configured to analyze knowledge graphs and other available data using, for example, edge analysis, graph analysis, and transformations, to detect anomalies or changes in campaign performance with triage and escalation. Once an anomaly is detected, anomaly detection service 564 may trigger predefined actions, such as, alerts sent to appropriate parties, retraining of models, changes to marketing content, and the like.

Scoring service 565 may be configured to generate an aggregate score for a marketing campaign based at least in part on analyzing the knowledge graph and other available data using, for example, edge analysis, graph analysis, and transformations. During initial steps, scoring service 565 may establish a baseline score for a marketing campaign. This may present an effective way to quantify a marketing campaign in an easy-to-understand manner and allow campaign managers to assess how and how impactful each change effects a marketing campaign.

This description has detailed a system for data extraction, processing, and management across multiple communication mediums, comprising: a connector service that creates a first dataset by gathering data of interest supplied by an interested party (user, client, external service provider); a data monitor and extractor that creates a second dataset by extracting data of interest from external sources (whether it be marketing campaign data, political campaign data, social trends, etc.); a knowledge graph constructor which compiles the first and second datasets into a graph and timeseries-based third dataset; and a data analysis service that processes and analyzes the third dataset by performing at least a plurality of graph computations and transformations and edge analysis to at least determine a data performance rating based at least on clickstream data; and a reporting service that compiles a real-time report in which at least a portion is based on clickstream data of the data of interest.

This example is one embodiment of a platform for data extraction, processing, and management across multiple communication platforms. Marketing campaign data may be abstracted to or considered as any data of interest. Large datasets of data of interest may be comprised of political, social, hobby, geographical, or other widely distributed information sets. Consider that any topic of interest by humankind is existing at this point in at least one or more analog or digital forms of storage. Whether a user of the system wants to know about marketing campaign data, geopolitical landscapes, technical and academic pursuits, business activities, or any other common or obscure topic, it may generally be found in at least some analog or digital form or fashion. Further, it is even more typical to find the most common topics distributed in vast swathes of formats and communication channels. The disclosed embodiments describe how to extract, process, and manage such heterogenous sourced and formatted data on any topic and is not limited to marketing campaign data however, marketing campaign data lends itself well to exemplify the invention.

### Detailed Description of Exemplary Aspects

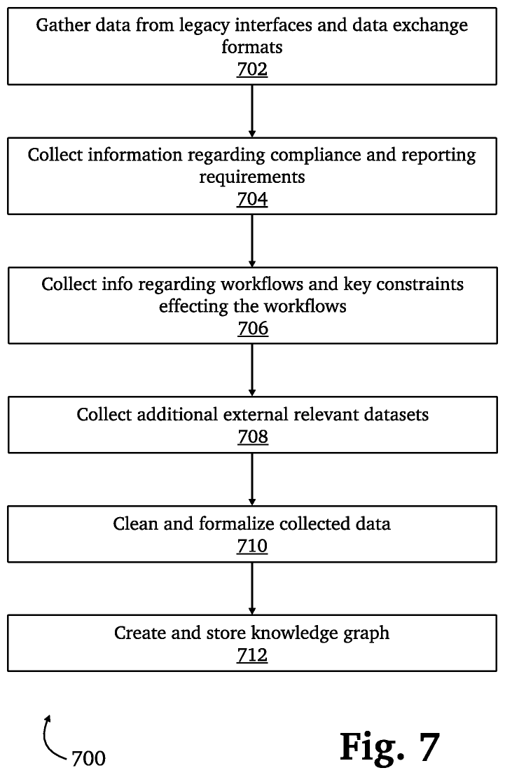

FIG. 7 is a flow chart illustrating a method 700 for initial data gathering according to various embodiments of the invention. At an initial step 702, legacy interfaces and data exchanges are detailed, and data gathered may be gathered from the interfaces and exchanges. The data may include clickstream data, marketing history, performance history, existing marketing campaigns, and the like. At step 704, information regarding any compliance and reporting requirements associated with a particular industry is collected. At step 706, information regarding workflows, and constraints which may affect those workflows are collected and documented. At step 708, additional external datasets are gathered from sources such as news outlets, blogs, social media platforms, and the like. At step 710, the collected data is cleansed and formalized prior to importing and storing to platform 510. At step 712, a knowledge graph is created from the cleansed data with knowledge graph constructor 580.

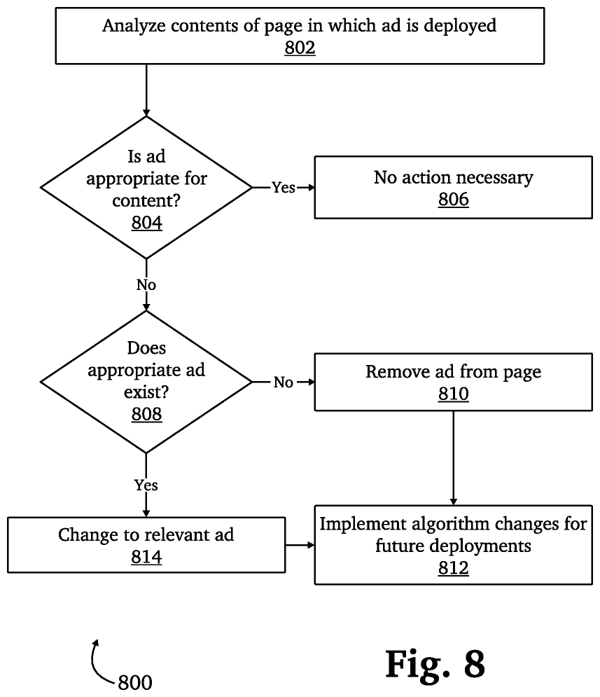

FIG. 8 is a flow chart illustrating a method 800 for contextual-based marketing adjustment according to various embodiments of the invention. At an initial step 802, contents of a page are extracted and analyzed to determine whether the contents of the page are relevant to a deployed ad, and whether the advertisement fits the sentiment of the context. At decision block 804, if the advertisement is fits the context of the page, the flow chart reaches step 806, where no further action is necessary. If the contents of the page, and the advertisement does not match the sentiment, the flow chart reaches decision block 808. At decision block 808, platform 510 checks whether an appropriate advertisement exists for the contents of the page. If an appropriate advertisement does not exist, the flow chart reaches step 810, where platform 510 connects to the applicable services or advertisement distributor to prevent the advertisement from appearing in future instances. At step 812, the marketing campaigns algorithms are adjusted to prevent future display of advertisements on the page, as well as pages with similar content.

On the other hand, if, at decision block 808, a relevant advertisement exists, the relevant advertisement is set to be displayed in future instances at step 814. At step 812, the marketing campaign algorithms are adjusted to display the relevant advertisement on the page, as well as pages with similar content.

To provide a specific example, an automotive manufacturer may have a marketing campaign to advertise their vehicles. With the present advertisement display metrics and algorithms established by the marketing department of the car manufacturer, the advertisement may be inadvertently displayed on a page reporting on decline in traffic safety. Platform 510 may determine that having the usual advertisement displayed alongside the report does not fit the sentiment and context. Instead, an advertisement regarding award-winning safety ratings of vehicles produced by the manufacturer may be displayed instead. In some embodiments, if an alternative advertisement isn't available, platform 510 may suggest creation of an additional advertisement for such content, or platform 510 may also be configured to automatically create a makeshift advertisement with available data. It will be appreciated by one skilled in the art that the above may also be applied to other mediums of advertisements, for example, streaming audio or video, without deviating from the inventive concept of the present invention.

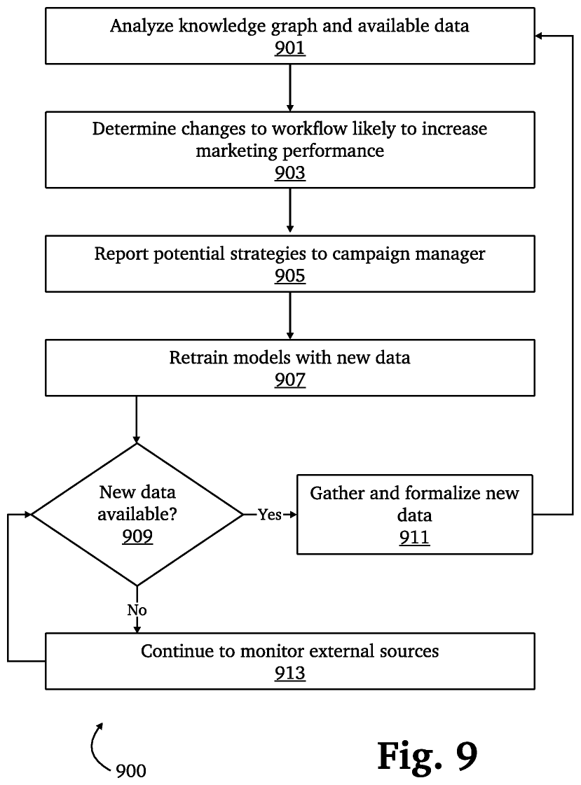

FIG. 9 is a flow diagram illustrating a method 900 for updating an existing marketing campaign with new data according to various embodiments of the invention. At an initial step 901, an existing knowledge graph and any other available data not part of the knowledge graph is analyzed using, for example, with automated planning service 130 or marketing data analysis service 560. At step 903, platform 510 determines and compiles marketing strategy changes or additions that may be made to the workflow that may result in favorable performance increases into a report. At step 905, platform 510 reports recommended strategies to a campaign manager. At step 907, platform 510 retrains models and makes changes to algorithms based at least in part on predictive analysis results, and choices made by the campaign manager. At decision block 909, platform 510 continuously monitors data sources for new data that may be useful in improving a marketing campaign, for example, using connector 135 and extractor 550. If new data is available, the data is gathered, cleansed, and formalized at step 911. The data may then be used to update the knowledge graph in real-time or stored into a data store. If no new data is available, platform 510 continues to monitor for new data at step 913.

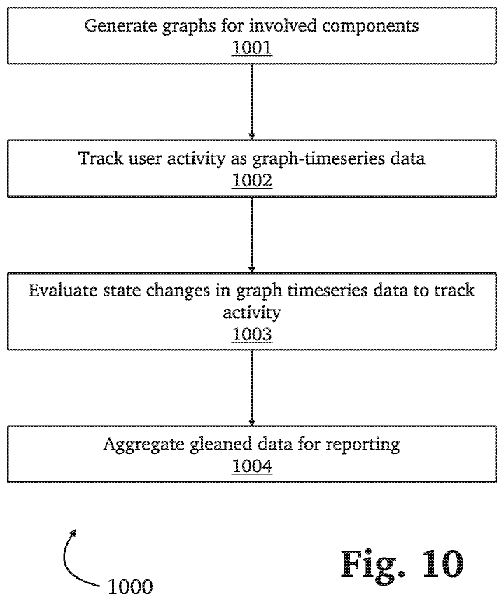

FIG. 10 is a flowchart illustrating an exemplary method 1000 for extracting data from graph-timeseries data analysis according to various embodiments of the invention. At an initial step 1001, graphs may be systematically generated using a graph stack service, a knowledge generator, and the like based on the requirements of a particular usage. This may involve, for example, generating a set of graphs for users, and websites to track user activity and interactions involving the tracked websites. At step 1002, activity and interactions amongst the graphs may be tracked and recorded as timeseries data. At step 1003, graph analysis may be performed on the graphs in conjunction with timeseries data using the applicable component of system 100 or platform 510. This may include, for example, configuring marketing data analysis service 560 to perform edge analysis on the data to determine and extract the clickstream data of one or more users, or configuring marketing data analysis service 560 perform edge analysis on the data to determine whether certain activity is suspicious or anomalous. At step 1004, gleaned data may be aggregated for reporting, or may be processed by other components of platform 510.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

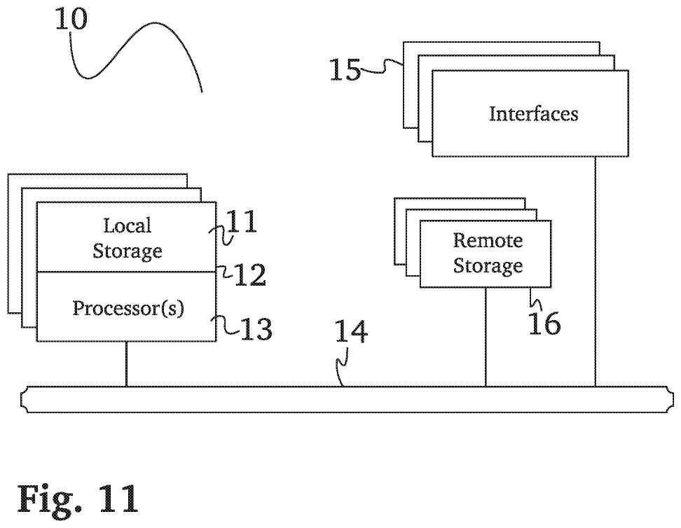

Referring now to FIG. 11, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™ THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 11 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

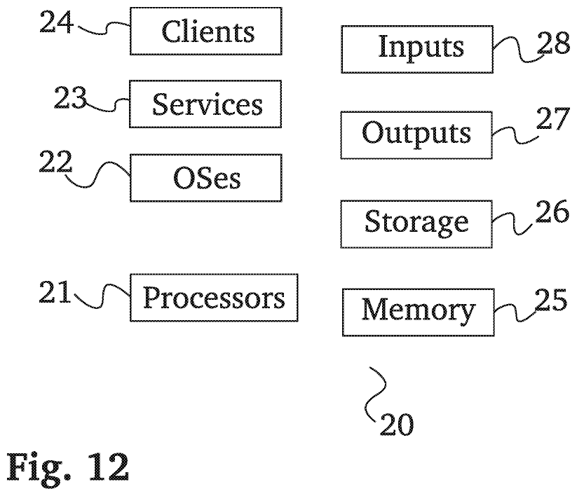

In some aspects, systems may be implemented on a standalone computing system. Referring now to FIG. 12, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 11). Examples of storage devices 26 include flash memory, magnetic hard drive, CD-ROM, and/or the like.

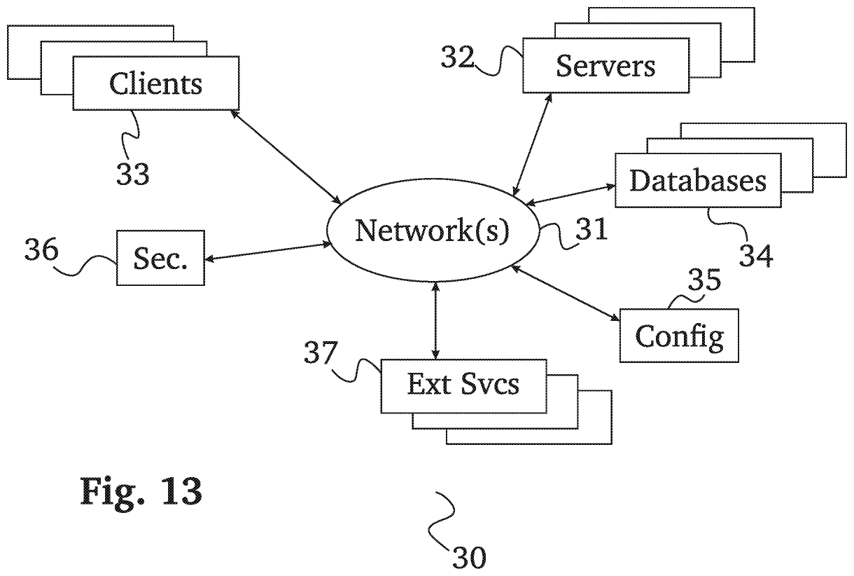

In some aspects, systems may be implemented on a distributed computing network, such as one having any number of clients and/or servers. Referring now to FIG. 13, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 12. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

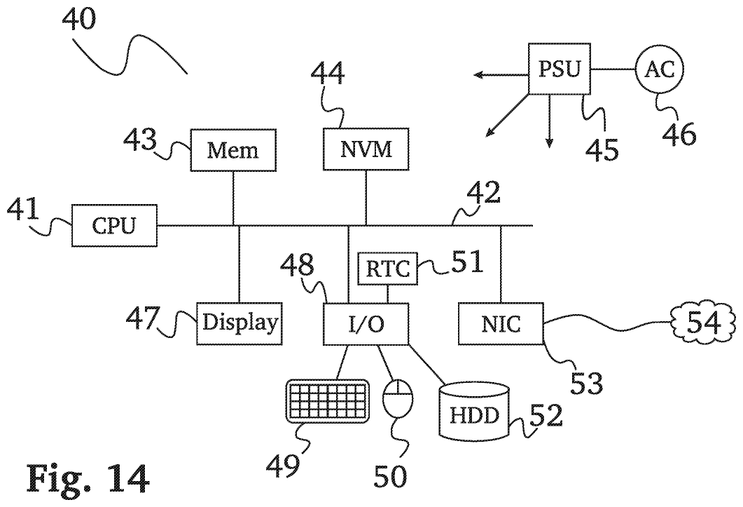

FIG. 14 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

What is claimed is:

1. A system for data extraction, processing, and management across multiple communication mediums, comprising:
a computing device comprising a memory, a processor, and a non-volatile data storage device;
a connector service comprising a first plurality of programming instructions stored in the memory and operable on the processor, wherein the first plurality of programming instructions, when operating on the processor, cause the computing device to:
create a first dataset by gathering data of interest supplied by an interested party;
a data monitor and extractor comprising a second plurality of programming instructions stored in the memory and operable on the processor, wherein the second plurality of programming instructions, when operating on the processor, cause the computing device to:
create a second dataset by extracting data of interest from external sources;
a knowledge graph constructor comprising a third plurality of programming instructions stored in the memory and operable on the processor, wherein the third plurality of programming instructions, when operating on the processor, cause the computing device to:
compile the first and second datasets into a graph and timeseries-based third dataset; and
a data analysis service comprising a fourth plurality of programming instructions stored in the memory and operable on the processor, wherein the fourth plurality of programming instructions, when operating on the processor, cause the computing device to:
process and analyze the third dataset by performing at least a plurality of graph computations and transformations and edge analysis to at least determine a data performance rating based at least on clickstream data; and
a reporting service comprising a fourth plurality of programming instructions stored in the memory and operable on the processor, wherein the fourth plurality of programming instructions, when operating on the processor, cause the computing device to:
compile a real-time report in which at least a portion is based on clickstream data of the data of interest.

2. The system of claim 1, further comprising an automated planning service comprising a memory, a processor, and a fifth plurality of programming instructions stored in the memory thereof and operable on the processor thereof, wherein the fifth programmable instructions, when operating on the processor, cause the processor to:
perform predictive analysis using at least the third dataset; and
determine steps for improving performance of the data of interest based at least on results of the predictive analysis.

3. The system of claim 1, wherein the connector service is configured to connect to an inventory tracking system to include inventory information in the third dataset.

4. The system of claim 1, wherein the data analysis service performs a plurality of graph analysis and transformations and edge analysis to conduct sentiment analysis to determine sentiment regarding the data of interest.

5. The system of claim 4, wherein the sentiment analysis is accomplished by natural language understanding.

6. The system of claim 1, wherein the data analysis service performs a plurality of graph analysis and transformations and edge analysis to conduct correlative analysis to determine a cause for change in performance for the data of interest.

7. The system of claim 1, wherein the first dataset gathers data regarding an associated marketing campaign from at least an external service provider by connecting through an application programming interface of the external service provider, wherein the associated marketing campaign comprises a deployed advertisement.

8. The system of claim 7, wherein the second dataset extracts data regarding the associated marketing campaign from external sources including at least social media sources.

9. The system of claim 8, further comprising a contextual-based adjuster comprising a sixth plurality of programming instructions stored in the memory and operable on the processor, wherein the sixth plurality of programming instructions, when operating on the processor, cause the computing device to:
retrieve a marketing context from a database stored on the non-volatile data storage device;
analyze the contents of a web page containing the deployed advertisement;
determine whether the contents of the web page are relevant to the deployed advertisement; and
where the contents of the web page are not relevant to the deployed advertisement, upload a different advertisement to the associated marketing campaign.

10. The system of claim 9, wherein the data analysis service performs a plurality of graph analysis and transformations and edge analysis to determine quality of advertisement traffic based at least on clickstream analysis.

11. A method for data extraction, processing, and management across multiple communication mediums, comprising the steps of:
creating a first dataset by gathering data of interest supplied by an interested party;
creating a second dataset by extracting data of interest from external sources;
compiling the first and second datasets into a graph and timeseries-based third dataset; and
processing and analyzing the third dataset by performing at least a plurality of graph computations and transformations and edge analysis to at least determine a data performance rating based at least on clickstream data; and
compiling a real-time report in which at least a portion is based on clickstream data of the data of interest.

12. The method of claim 11, further comprising an automated planning service comprising a memory, a processor, and a fifth plurality of programming instructions stored in the memory thereof and operable on the processor thereof, wherein the fifth programmable instructions, when operating on the processor, cause the processor to:
perform predictive analysis using at least the third dataset; and
determine steps for improving performance of the data of interest based at least on results of the predictive analysis.

13. The method of claim 11, wherein the connector service is configured to connect to an inventory tracking system to include inventory information in the third dataset.

14. The method of claim 11, wherein the data analysis service performs a plurality of graph analysis and transformations and edge analysis to conduct sentiment analysis to determine sentiment regarding the data of interest.

15. The method of claim 14, wherein the sentiment analysis is accomplished by natural language understanding.

16. The method of claim 11, wherein the data analysis service performs a plurality of graph analysis and transformations and edge analysis to conduct correlative analysis to determine a cause for change in performance for the data of interest.

17. The method of claim 11, wherein the first dataset gathers data regarding an associated marketing campaign from at least an external service provider by connecting through an application programming interface of the external service provider, wherein the associated marketing campaign comprises a deployed advertisement.

18. The method of claim 17, wherein the second dataset extracts data regarding the associated marketing campaign from external sources including at least social media sources.

19. The method of claim 18, further comprising a contextual-based adjuster comprising a sixth plurality of programming instructions stored in the memory and operable on the processor, wherein the sixth plurality of programming instructions, when operating on the processor, cause the computing device to perform the steps of:
retrieving a marketing context from a database stored on the non-volatile data storage device;
analyzing the contents of a web page containing the deployed advertisement;
determining whether the contents of the web page are relevant to the deployed advertisement; and
where the contents of the web page are not relevant to the deployed advertisement, uploading a different advertisement to the associated marketing campaign.

20. The method of claim 19, wherein the data analysis service performs a plurality of graph analysis and transformations and edge analysis to determine quality of advertisement traffic based at least on clickstream analysis.
